(19) United States
(12) Patent Application Publication
(10) Pub. No.: US 2003/0009594 A1
(43) Pub. Date: Jan. 9, 2003

(54) Method and apparatus for identifying locale of internet users

(76) Inventor: Adrian McElligott, Durack (AU)

Correspondence Address: CONLEY ROSE & TAYON, P.C., P. O. BOX 3267, HOUSTON, TX, 77253-3267, US

(21) Appl. No.: 10/182,521

(22) PCT Filed: Feb. 5, 2001
(86) PCT No.: PCT/AU01/00096

(30) Foreign Application Priority Data
Feb. 4, 2000 (AU) PQ 5456

(51) Int. Cl. G06F 15/173; G06F 15/16

(52) U.S. Cl. 709/245; 709/238

(57) ABSTRACT

A method for a web-server host H (11) to determine the network address of a router or other network support device (10) most directly connected to a network connected computational device M such as a PC (12). In a preferred embodiment Host (11) is able to determine the geographical location of router (10), and hence the approximate geographical location of PC (12). The host may transmit information geographically relevant to PC (12) such as advertisements for locally available goods and services.

### FIELD OF THE INVENTION

The present invention is concerned a method for determining the network address of a network support device closest to a computer network accessing computational device, such as a personal computer. The invention further relates to a method for determining the approximate geographical locale of an internet accessing computational device, such as a personal computer.

### BACKGROUND TO THE INVENTION

At present it is not possible for a web server to non-intrusively determine with any degree of accuracy the geographical location of users accessing it. By “geographical location” is meant the approximate locality, such as town, city, or rural region where the user is located. Consequently it is only possible for the accessed web-site to make geographically specific the information presented to a remote user on the basis of information provided by the user. For example, a user may access a web-page which provides information on entertainment available in all the capital cities of a particular country. However the user must provide information to the web-site as to the city that he/she inhabits, in order to be provided with appropriate information. The web-page can not be programmed to automatically provide information appropriate to the user's location because it is not possible to ascertain the location without the user submitting that information.

Another example where it would be desirable to be able to provide locality customised information is in the realm of internet advertising. At present when a user accesses a web page such as an internet search engine the web page provider inserts advertisements onto the page of search results. Such advertising space is sold to businesses and the revenue provides income for the web-site provider, however because the locality of the user is unknown the web page advertisements are not well targeted to the user. The vast majority of advertisers are currently being excluded from advertising on the internet as they simply can't afford, or don't want, to target potential customers in far flung geographical locations. For example the local newspaper in Miami does not want to advertise itself to viewers in Colorado. The advertising of local product to local consumers is almost non-existent on the internet when compared with traditional media where in excess of 80% of advertising is in respect of local product offered to the local market. In particular regional businesses, which provide services only in fairly specific geographical regions, are not inclined to purchase advertising space from internet web-page providers. Recently, it has been estimated that 75% of all internet advertising inventory goes unsold, this over-supply has resulted in downward pressure on CPM prices

It is an object of the present invention to provide a method for determining the IP address of the closest internet support device, to an internet accessing machine given the IP address of the machine.

### SUMMARY OF THE INVENTION

According to a first aspect of the present invention there is provided a method for determining the network address of a network support device in most direct communication with a computer network accessing computational device, said method including the steps of:

transmitting a burst of messages having a range of time-to-live (TTL) values, each message including a network address of said computational device and having a copy of its initial time-to-live value embedded as a constant value in the message, whereby response messages generated by the network support devices and said computational device in response to said burst of messages incorporate said initial time-to-live values; and

determining said address of th network support device on the basis of the type of response message received and said incorporated initial time-to-live values.

Typically the computer network is the Internet wherein Internet Protocol (IP) addresses are used to identify the network support devices and wherein the network support devices are programmed to respond to the burst of messages with response messages according to the Internet Control Message Protocol (ICMP).

Preferably the step of determining said address includes examining the response messages and extracting from said messages the address of the network support device returning a message of the ICMP_TTL_exceeded type with the highest time-to-live (TTL) value embedded as a constant value of the response messages.

The step of determining said address may include determining said address by recording the lowest TTL value embedded as a constant amongst ICMP_Echo_Reply type messages and then retrieving an originating address of a message having an embedded TTL value of one less than said lowest TTL value.

Where ICMP_machine_unreachable type response messages are received then the step of determining said address may be include determining said address by recording the originating address of an ICMP_machine_unreachable type response message. According to a further aspect of the present invention there is provided a method for determining the approximate geographical location of a data network accessible computational device located remotely from a host, said method including the steps of:

accessing a database relating network support device identity to geographical location;

determining the identity of a network support device appearing in said table most directly connected to said computational device; and

looking up a geographical location in said database related to said determined network support device. Preferably the method further includes the step of compiling said database by operating a website requesting remote users of the site to transmit their geographical location and from responses to said request recording provided geographical locations in association with the address of the nearest network support, said address being determined according to the previously described method of the first aspect of the invention.

The method may further include providing data to said computational device relevant to the geographical location of the computational device.

Typically said data includes advertisements in respect of goods and/or services available in the geographical location.

According to another aspect of the invention there is provided a computational device connected to the internet, the computational device including processing means operatively arranged to produce a burst of ICMP data messages having initial time-to-live values stored in a data field of each message, said processing means being further operatively arranged to determine the nearest network device to a given IP address on the basis of ICMP data messages received over the network in response to said burst.

Preferably the computational device is in communication with an electronic storage medium containing a database relating IP addresses of routers to geographical locations.

According to a final aspect of the present invention there is provided a software product stored upon a computer readable medium for execution by a computer, the software product including:

message generation instructions for generating modified ICMP messages, said messages including a constant time-to-live (TTL) value and the IP address of a remote computational device;

message transmission instructions for transmitting said modified ICMP messages to said IP address;

message reading instructions for reading response messages received in response to said modified ICMP messages;

address determination instructions for determining the address of a network support device in most direct communication with the remote computational device on the basis of data provided by the message reading instructions.

Preferably the message reading instructions include response type instructions for determining the type of a response message, the embedded TTL value and the address of a network support device originating said response message.

The address determination instructions may include instructions for determining if a response message contains the IP address of the network support device in most direct communication with the remote computational device on the basis of the type of the response message and the embedded TTL value of the response message Furthermore, the address determination instructions may also include instructions for extracting from said response messages the address of the network support device returning a message of the ICMP_TTL_exceeded type with the highest embedded TTL value of the response messages.

Preferably the address determination instructions include instructions for determining said address by recording the lowest TTL value embedded as a constant amongst ICMP_Echo_Reply type messages of the response messages and then retrieving an address of a response message having an embedded TTL value of one less than said lowest TTL value.

The address determination instructions may also include instructions for determining said address by recording the originating address of an ICMP_machine_unreachable type response message.

In order that this invention may be more readily understood and put into practical effect, reference will now be made to the accompanying drawings which are used in an explanation of a preferred embodiment of the invention.

### BRIEF DESCRIPTION OF THE FIGURES

FIG. 1 is a schematic diagram of a relationship between a user's internet terminal, a web server and a geographical location resolution server as may be provided in accordance with the present invention.

FIG. 2 is a schematic diagram of a portion of the internet between a host such as a web server and a user terminal.

FIG. 3 is a further schematic diagram showing routers linearly connected between a host and a web server for purposes of explanation.

FIG. 4 is a schematic diagram of an ICMP_Echo/ICMP_EchoReply data packet.

FIG. 5 is a schematic diagram showing the type of ICMP data packets generated in response to a burst of ICMP_Echo messages in accordance with the present invention, in the case where the IP address of the ICMP_Echo messages is unresponsive.

FIG. 6 is a schematic diagram showing the type of ICMP data packets generated in response to a burst of ICMP_Echo messages in accodance with the present invention, in the case where the IP address of the ICMP_Echo messages is responsive.

FIG. 7 is a block diagram of a method for identifying a router nearest to a given IP address.

FIG. 8 is a block diagram of a method for identifying a router nearest to a given IP address and the relative position of the router between a host and a user terminal.

### DETAILED DESCRIPTION OF PREFERRED EMBODIMENTS

There is no geographic relationship between two IP addresses, other than those that share the same subnet. For example, it is quite likely that machines having addresses 203.30.195.10 and 203.30.195.11 are geographically close but there is no such nexus between IP addresses of different subnets like 203.30.195.10 and 203.30.196.10. Consecutive network addresses 203.30.195 and 203.30.196 could be on opposite sides of the globe, and are more than likely not geographically close.

In order to relate every possible subnet to a geographical location could theoretically require determining the geographical location of up to 256×256×256 (or 16,777,216) subnets. Additionally the maintenance of such a table may very well be more difficult than its original construction because there is no way of automatically knowing when a subnet has been moved, or of knowing the location of a newly created subnet. It is also not possible to use the data obtained for one subnet to confirm or verify data obtained for another.

The geographical location of an IP address can be deduced if the geographical location of an IP address that shares the same router is known. Given this assumption, the problem is one of identifying the common network infrastructrure between two given subnets. A method of doing this is to identify the subnet's gateway, referred to herein as the subnet's nearest router.

Once the nearest router to a subnet whose geographical location is known, has been identified, then the geographical location of all other subnets which share this common nearest router can be deduced. This assumption applies to network terminating subnets, to which end-user PC's are generally connected.

One method for compiling a table relating router identity to geographical location is to set up a web page which provides an incentive for users to voluntarily provide their geographical location. It is assumed that in the great majority of cases the geographical location of the user is approximately the same as the location of the nearest router.

Once the user has provided the geographical location then the identity of the nearest router to the user may be determined in a manner which will be described shortly. The router identity is stored in a table with the geographical location information. The subnet IP address is also stored with its related geographical information.

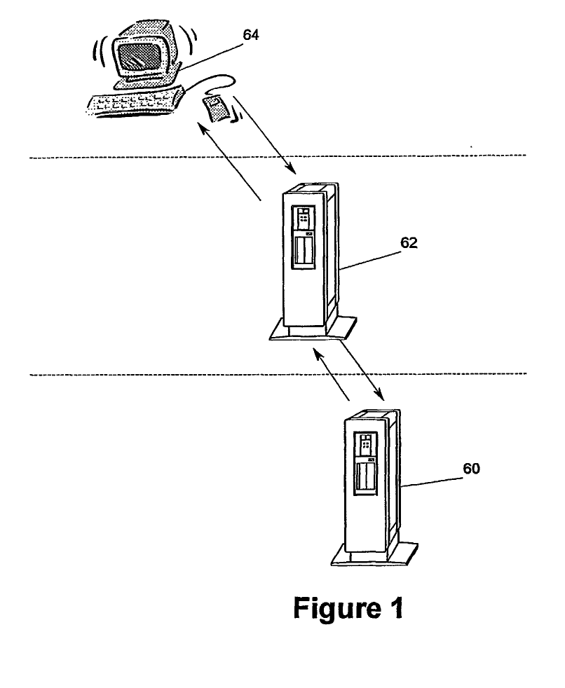

With reference to FIG. 1 a Geographical Location Resolution Server (GLRS) 60 may be constructed which stores the router location table and is also programmed to determine the nearest router to a given IP subnet address. A web server or portal 62 may support a search engine which is accessed by an end-user's PC 64. The end user initially sends a data packet to server 62 which includes the subnet address of PC 64. Server 62 in turn forwards the subnet address of the user to the GLRS. The GLRS checks its database to see if it has the location of the subnet readily available. If the subnet is already in the database then all that is required is a database lookup of the subnet's nearest router ID. However if the subnet is not within the database then the nearest router to PC 64 will have to be identified and that router ID used to determine a geographical location from the router ID-location table for terminal 64. The geographical location data is then transmitted from the GLRS to web server 62. The web server given the geographical data customises the web page data that is presented to the user. For example the customisation might involve displaying an advertisement on the web-page of a service available from a business in the geographical area determined by the GLRS

A preferred method for determining the identity of the router nearest to a given IP address will now be explained. In use the method is typically programmed as a software application that is run on GLRS 60. Alternatively the functionality of the GLRS could be incorporated directly into the web-server 62.

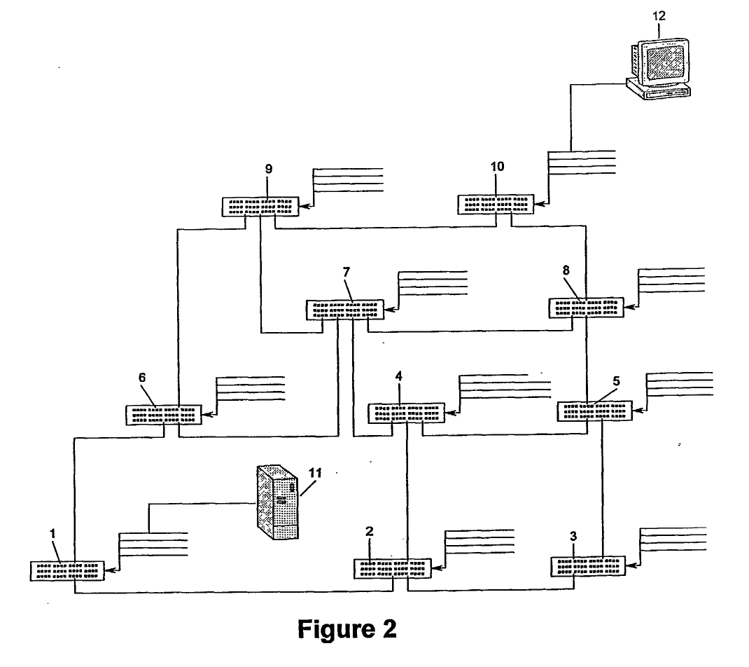

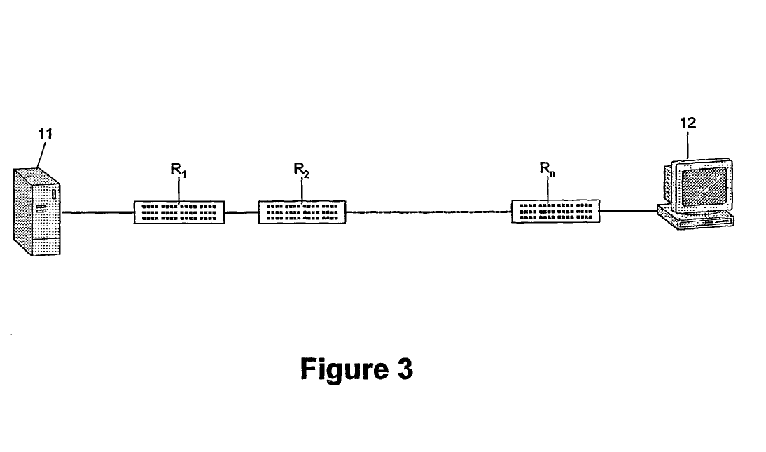

Referring now to FIG. 2 there is depicted a generalised portion of the internet. Between a web-page host H (item 11) and a user machine M (item 12), such as a personal computer there may be many different paths supported by routers, gateways or other network support devices (items 1-10). However, due to standard address tables stored in each router data packets between the host and the machine generally take the same path. Accordingly in order to explain the present invention the path between host H and machine M may be represented as shown in FIG. 3.

With reference to FIG. 3 it will be noted that there are a number of routers R1, . . . , Rn interconnecting H and M. The internet protocol (IP) facilitates data communication between H and M via routers R1, . . . , Rn. An integral part of IP is the Internet Control Message Protocol (ICMP). ICMP messages are generated by routers, and other network support devices, in several situations: for example, when a data packet cannot reach its destination, when a router does not have the buffering capacity to forward a data packet, and when the time-to-live parameter of a data packet has been exceeded. ICMP is documented in internet Request For Comment document (RFC) 792.

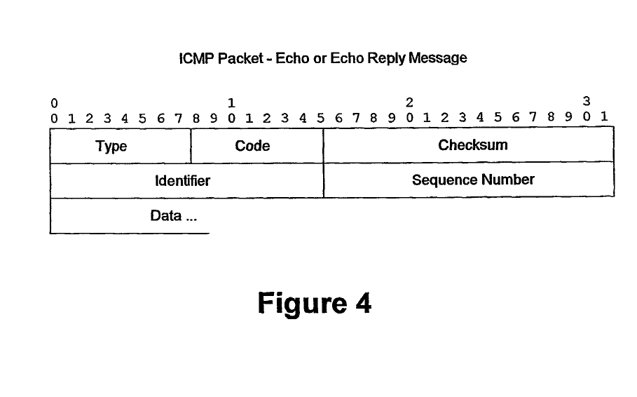

FIG. 4 schematically depicts a type 8 ICMP message. Type 8 is an echo or echo-reply ICMP message. The address of the source in an echo message will be the destination of the echo reply message. That is, to form an echo reply message, the source and destination addresses are simply reversed. ICMP messages are sent using a basic IP header. The first octed of the data portion of such a data packet is an ICMP type field. In the present case the type field is set to type 8. The IP header also includes a time-to-live (TTL) field. This field takes an integer value that is decremented at each machine at which the data packet is processed during its passage across the network. In standard use the value of the TTL field is set to be at least as great as the number of routers which the data packet will have to traverse, otherwise the data packet will not reach its destination but rather will time-out as it traverses the network.

According to the present invention Host H transmits a burst of ICMP Echo messages each with the IP address of machine M and each having a different TTL value. For example, the burst of messages may comprise say 42 messages with TTL values ranging from 1 to 42. Apart from the TTL value being present in the header, as is standard, the TTL value is also embedded in the “sequence-number” portion of the packet. As a packet passes along the router chain the TTL value in the header is decremented by each router which processes the data packet. Depending on the original value of the TTL header value the packet may or not reach machine M. If the TTL value is larger than the number of routers to be traversed then the packet will reach machine M and, in the event that the machine is responsive, an Echo-Reply message will be generated by machine M and transmitted back to Host H. Importantly the Echo-Reply message will have embedded within it the original TTL value which was embedded in the sequence-number portion of the initial ICMP_EchoReply message. Alternatively, if the TTL value of the packet in question is lower than the number of routers to be traversed then the data packet will time out at one of the routers. In that case the router at which the time-out occurs will generate a ICMP_TTL_Exceeded message (ICMP type 11) addressed to the host. According to the ICMP the TTL exceeeded message generated will include 64 bits of the original ICMP_Echo message, including the embedded TTL value of the original message.

Another possibility is that machine M is switched off or otherwise inaccessible to messages over the network. In the event that machine M is indeed inaccessible then it is common practice that the router nearest to machine M be programmed to detect that machine M is unreachable. In that case the nearest router will generate an ICMP Destination Unreachable message (ICMP type 3) for transmission back to the originating host H. The Destination Unreachable message will include 64 bits of the original ICMP_Echo message, including the embedded initial TTL value of the original message.

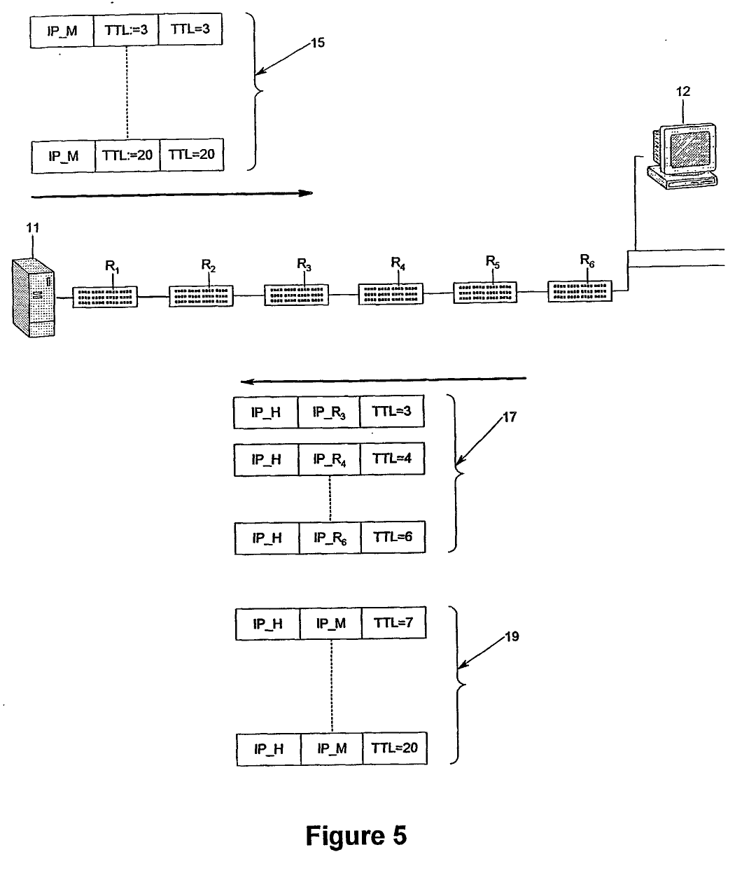

With reference to FIG. 5, a method for determining the address of the router nearest to machine M will now be explained. According to the present invention host H generates a burst 15 of, for example, eighteen ICMP-Echo data packets having TTL values ranging from TTL=3 to TTL=20. It being assumed that machine M is between three and twenty hops away from H. Each of the packets includes IP-m, the IP address of M, in its header and also an original TTL value. The original value is also embedded in the “sequence number” field of the data packet as previously explained.

Supposing that machine M is reachable then ICMP_TTL_Exceeded “packets” or messages 17, will be composed and returned from routers R3, . . . , R6 in response to the ICMP_TTL_Exceeded messages with initial TTL header values of TTL=3, . . . , 6. The ICMP_TTL_Exceeded packets include the address IP-Rn of the router port through which the data packet was transmitted, and the original TTL values, in the range of TTL=j, . . . , TTL=k. Here j is the lowest TTL value that was used (in the present example j=3) and where k is the number of routers in the path from H to M. In the present example k=6). As machine M is reachable in this case ICMP_EchoReply data packets 19 will be returned from machine M. These data packets include IP-m which is the subnet address of M and TTL values ranging from TTL=k+1 to TTL=n where n is the largest TTL value that was used in the original burst of ICMP-Echo data packets (in the present example n=20). In order to determine which router is closest to machine M it is necessary to detect a returned ICMP data packet having an embedded TTL value of k and then retrieve the IP-Rn address from that data packet. In the present example k=6 therefore the ICMP_TTL_Exceeded data packet having the highest TTL value will contain the address of the nearest router. Alternatively, the ICMP_EchoReply data packet having the lowest embedded TTL value will have a TTL of k+1. Consequently another way for determining the nearest router is to firstly determine the data packet having TTL=k+1 and then wait for the data packet with TTL=k and from that packet retrieve the IP-Rn address, which is the address of the router nearest to M.

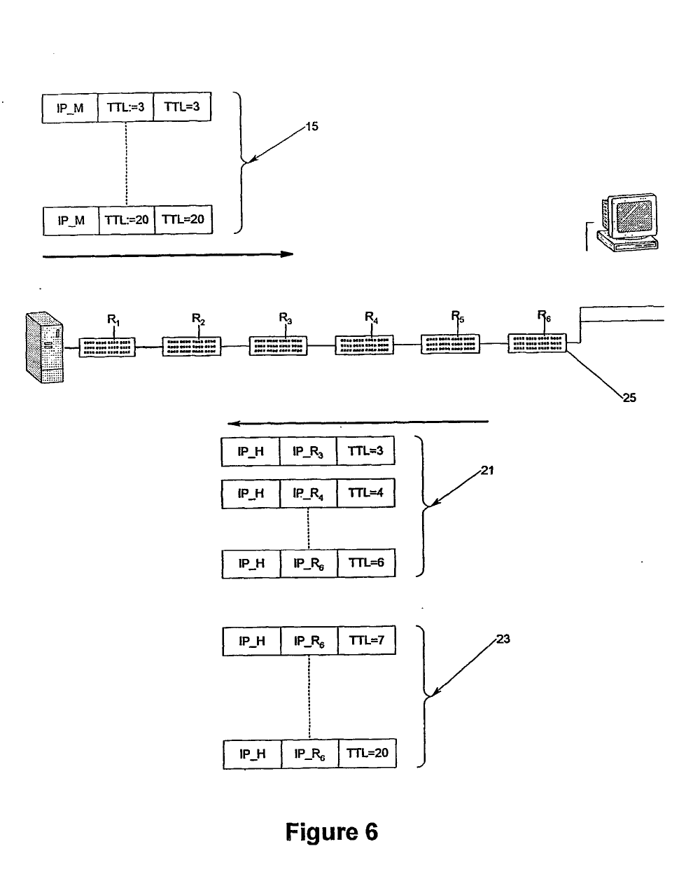

With reference to FIG. 6, in the event that the machine M is unreachable, for example it may be switched off, then no ICMP_EchoReply packets will be generated. However ICMP_TTL_Exceeded messages 21 will be produced as before. ICMP_Machine_Unreachable data packets 23 may also be produced by the router closest to M, depending on how the nearest router R6, (item 25) is programmed. If the nearest router is programmed to produce ICMP_Machine_Unreachable data packets then such data packets having embedded TTL values in the range 7-20 will be produced. These data packets will all include the address of the router nearest to M. If the nearest router is not programmed to produce ICMP_Machine_Unreachable data packets then the nearest router address may be determined from the returning TTL-exceeded message having the greatest TTL value.

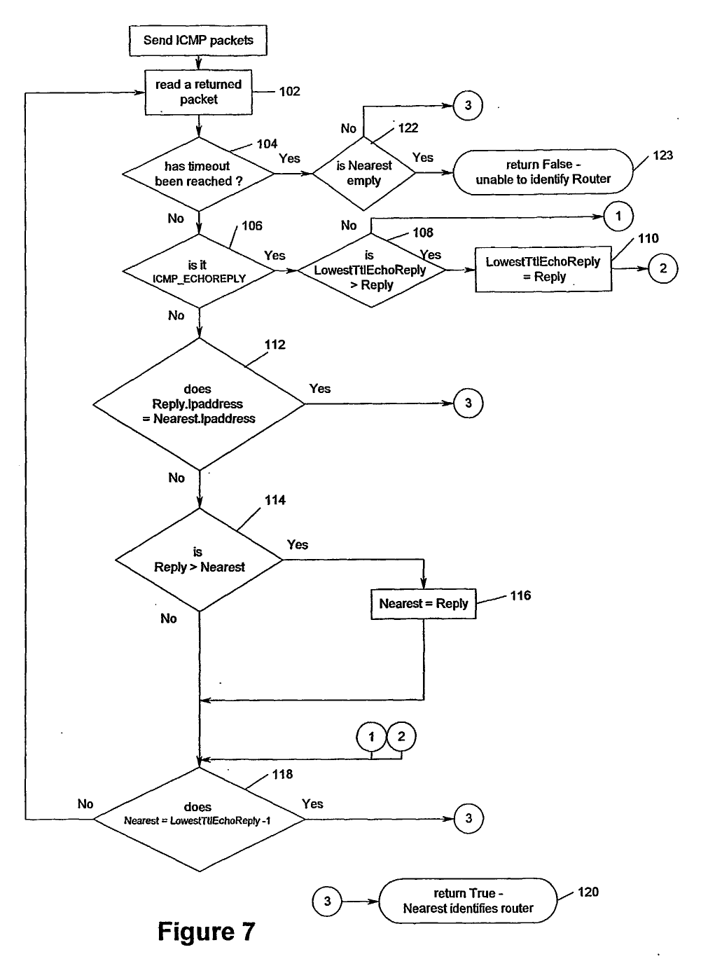

Referring now to FIG. 7 there is depicted a flow chart of a computer program used to determine the address of the router nearest machine M. Initially at block 100 a burst of ICMP_Echo packets having TTL values over a range of, for example 3 to 20, are generated. The ICMP_Echo packets are customised as previously explained by having the original TTL value embedded in the sequence number portion of the packet. A timeout counter is set to zero and a variable “Nearest” is initialised. The Nearest variable is a data object having an integer field for storing TTL values and a string field for storing router IP addresses. At initialisation both the string and integer components are set to nil. A second variable Reply is of the same type as Nearest. The reply variable is used for storing IP address and TTL values from each returned ICMP packet that is processed.

Shortly after transmitting the burst of data packets response packets are returned over the network. The response packets are not in any particular order however they all contain embedded initial TTL values from the originating ICMP_Echo packet burst. At box 102 a response-packet is read and its type determined, e.g. ICMP_EchoReply, ICMP_TTL_Exceeded, ICMP_Machine_Unreachable. The embedded TTL value and the address of the router which originated the response packet are also extracted and are stored in the Reply variable. At box 104 a check is made to determine whether or not the time limit for determination of the nearest router has been reached. In the event that the time limit has not been reached then control branches to decision box 106. The time limit is necessary as under some network fault conditions very few or no packets may be received. In that case it is undesirable that the method waits indefinitely for packets to process.

If the response packet is determined to be an ICMP_EchoReply type then it must be the case that M is reachable and has generated the response packet. As discussed in relation to FIG. 5 the ICMP_EchoReply packet with the lowest embedded TTL value will have an embedded value of TTL=k+1 where k is the number of routers in the path. If the response packet is an ICMP_EchoReply packet then control branches to box 108. The variable LowestTtlEchoReply stores the lowest embedded TTL value retrieved from response packets of the ICMP_EchoReply type. LowestTtlEchoReply is updated at box 110 if the TTL value stored in Reply, is less than the value presently stored in LowestTtlEchoReply. Control then diverts to box 118 where a check is undertaken to determine if the TTL value stored in the Nearest variable, which should be k is equal to the TTL value in LowestTtlEchoReply (which should be k+1) minus 1.

If that condition is met then the procedure terminates with the address of the router nearest machine M being stored in the data string component of the Nearest variable.

It may be that at box 106 it is found that the response packet being processed is not an ICMP_EchoReply type. In that case it is inferred that the response packet originated at a router. If the address of the router is not the same as the address stored in Nearest then control diverts to box 114. At this point it is known that the response packet originated at a router on the path between H and M but it is not known how far along the path from H to M the router is located. If the TTL value that was retrieved from the response packet is greater than the value presently stored in Nearest then it must be the case that the current response packet originated further along the path than any of the previous ones which originated at routers. In that case control branches to box 116 and Nearest takes the TTL value and IP address of the current response packet, which are stored in Reply. Control then flows to box 118, which performs a check as previously explained.

If at box 112 it is found that the IP address stored in Nearest is equal to the IP address stored in Reply then it must be the case that at least two messages have originated from a router having the IP address in question. The only circumstance under which such a situation could have arisen is where the router nearest M has generated a number of ICMP_Machine_Unreachable type messages. As explained with reference to FIG. 6, only the router nearest to M may generate multiple messages in the event that M is unreachable. Consequently if the condition at box 112 returns true then it is immediately known that the IP address stored in Nearest is the desired address and control diverts directly to box 120 which flags the successful completion of the process.

It may be that at box 104 the timeout for the overall process is reached, in that event if Nearest stores an IP address then that address is taken to identify the nearest router to M and the process diverts at box 120. Alternatively if Nearest does not store an IP address then the process terminates unsuccessfully at box 122.

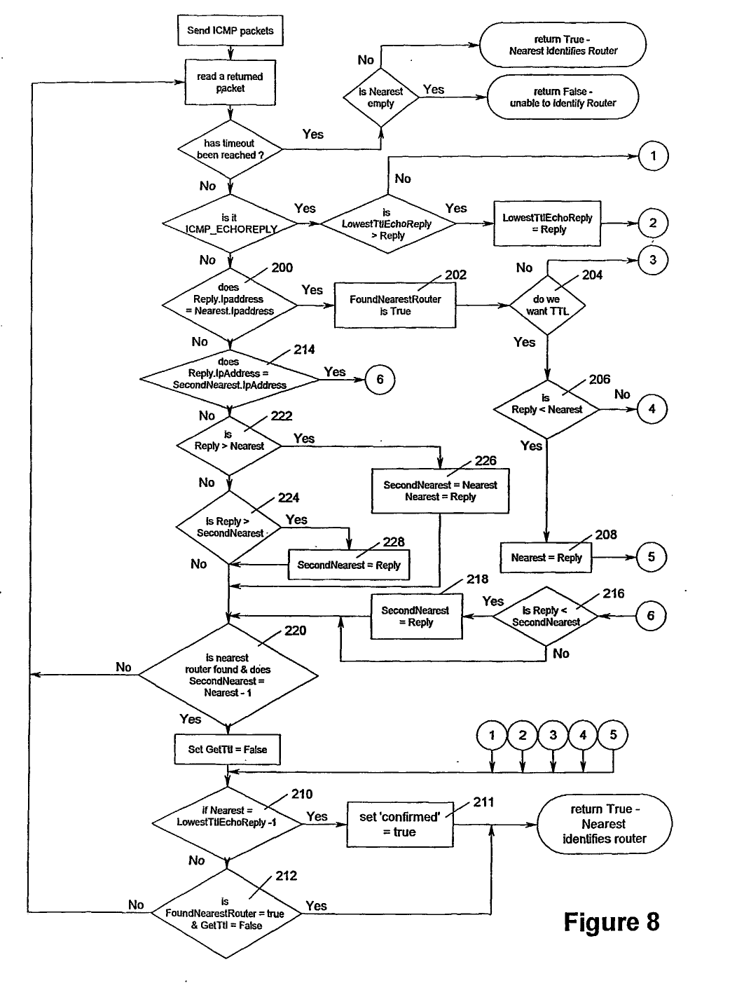

Although the method of FIG. 7 returns the IP address of the nearest router to M it only provides information as to the IP address of the nearest router to M, and how many routers from H the nearest router to M is located if the process successfully terminates through box 118. That is, it is not known what the minimum TTL value of an ICMP_Echo message originating from H would be that would be capable of reaching the nearest router without timing out if the process terminates through box 112. The flow chart of FIG. 8 depicts a method which does determine the minimum TTL value associated with the nearest router. The methodology of the flowchart of FIG. 8 is similar to that of FIG. 7 with respect to handling of the timeout variable and ICMP_EchoReply packets. Where it differs is in handling ICMP_MachineUnreachable messages and ICMP_TTL_Exceeded messages. At box 200 in the event that a repeat ICMP response message is detected then it is known that the IP address of the router nearest to M has been found, as explained with reference to box 112 of FIG. 7. Accordingly, a boolean variable FindNearestRouter is set to True at box 202. At box 204 if it is desired to determine the number of hops from M to the nearest router then control diverts to box 206 where the TTL value of the currently processed data packet is compared with the value held in the Nearest variable. It will be recalled that the lowest embedded TTL value of all the ICMP_Machine_Unreachable messages is equal to the number of hops from H to the nearest router to M. Nearest tracks the lowest embedded TTL value in a received ICMP_Machine_Unreachable message. Control flows from box 208 to decision box 210 which specifies conditions for successful termination of the process.

If at box 200 duplicate replies from the same router are not detected then control passes to box 214 which tests the address of the reply against the variable SecondNearest. SecondNearest serves two purposes, in this case being to detect a “ping-ponging” router condition. If this condition is detected then it is inferred that this reply is from the SecondNearest router, and control passes to box 216 where it is determined whether or not the reply has a lower TTL than the currently stored SecondNearest.

If so then the value of the current reply is stored in SecondNearest, in box 218, and control is then passed to box 220.

If the reply was not caught by box 214 as part of a response from a pingpong condition then control passes to box 222 which serves in a similar way to box 114 in FIG. 7. Likewise, box 226 serves the same purpose as box 116 in FIG. 7. In contrast to the process of FIG. 7 however, in the event that the reply variable is not greater than Nearest then control passes to box 224 where reply is used to track the SecondNearest router similarly to the operation of the process of FIG. 7 in relation to the Nearest variable.

Control then passes to box 220 where the second purpose for Nearest is used, and that is to be able to use the TTL of the second nearest router, once it is known to identify when the lowest TTL of the Nearest Router has been received. If this condition is true then a boolean variable GetTtl is set to false in order to facilitate final termination through box 212. Control is then passed to box 210.

Box 210 fulfills the same role as box 118 in FIG. 7, and if true passes control to box 211 which records that the reply was most certainly received from the last router. This confirmed find is used as a return parameter from the function.

In order to determine the number of hops to the nearest router it is necessary to identify either the LowestTtlEchoReply in combination with the highest TTL Non-Echo Reply or the Lowest Repetitive Non-Echo Reply in combination with the highest non-repetitive Non-Echo Reply. Boxes 210 and 212 test for both of these exit conditions.

In order to optimise the efficiency of the previously described methods it is envisaged that it be implemented in software and be run by concurrent processes on the GLRS. In order to do so, each ICMP_Echo message that is transmitted in the burst is encoded to allow determination of the process that originated it. The identifier and sequence number fields of the IMCP_Echo data packets are constructed in the following way to facilitate reliable identification under concurrent operation. The identifier field is used to identifiy the process that sent the original ICMP_Echo message.

It is possible to extend the number of concurrent processes to 65536. The sequence number field is split into two components of 10 and 6 bits respectively. The first 10 bits are used to distinguish concurrent operations from the same thread, limiting concurrent operations on the same thread to 1024. As previously explained the remaining 6 bits are used to store the TTL of the original ICMP_Echo message. The maximum number of concurrent operations is the product of the maximum number of threads by the number of operations per thread which is 65536×1024 or 67108864. The actual break up the four bytes comprising Identifier and Sequence number would in practice be optimised for the operating system being used.

Although the present invention has been described with reference to a limited number of embodiments it will be realised that variations and further embodiments are possible and within the scope of the following claims.

1. A method for determining the network address of a network support device in most direct communication with a computer network accessing computational device, said method including the steps of:
transmitting a burst of messages having a range of time-to-live (TTL) values, each message including a network address of said computational device and having a copy of its initial time_o-live value embedded as a constant value in the message, whereby response messages generated by the network support devices and said computational device in response to said burst of messages incorporate said initial time-to-live values; and
determining said address of th network support device on the basis of the type of response message received and said incorporated initial time_o-live values.

2. A method according to claim 1, wherein the computer network is the Internet wherein Internet Protocol (IP) addresses are used to identify the network support devices and wherein the network support devices are programmed to respond to the burst of messages with response messages according to the Internet Control Message Protocol (ICMP).

3. A method according to claim 2, wherein the step of determining said address includes examining the response messages and extracting from said messages the address of the network support device returning a message of the ICMP_TTL_exceeded type with the highest time-to-live (TTL) value embedded as a constant value of the response messages.

4 A method according to claim 2, wherein the step of determining said address includes determining said address by recording the lowest TTL value embedded as a constant amongst ICMP_Echo_Reply type messages and then retrieving an originating address of a message having an embedded TTL value of one less than said lowest TTL value.

5. A method according to claim 2, wherein the step of determining said address includes determining said address by recording the originating address of an ICMP_machine_unreachable type response message.

6. A method for determining the approximate geographical location of a data network accessible computational device located remotely from a host, said method including the steps of:
accessing a database relating network support device identity to geographical location;
determining the identity of a network support device appearing in said table most directly connected to said computational device; and
looking up a geographical location in said database related to said determined network support device.

7. A method according to claim 6, further including the step of compiling said database by operating a website requesting remote users of the site to transmit their geographical location and from responses to said request recording provided geographical locations in association with the address of the nearest network support, said address being determined according to claim 1.

8. A method according to claim 6 or claim 7, further including providing data to said computational device relevant to the geographical location of the computational device.

9. A method according to claim 8, wherein said data includes advertisements in respect of goods and/or services available in the geographical location.

10. A computational device connected to the internet, the computational device including processing means operatively arranged to produce a burst of ICMP data messages having initial time-to-live values stored in a data field of each message, said processing means being further operatively arranged to determine the nearest network device to a given IP address on the basis of ICMP data messages received over the network in response to said burst.

11. A computational device according to claim 10, in communication with an electronic storage medium containing a database relating IP addresses of routers to geographical locations.

12. A software product stored upon a computer readable medium for execution by a computer, the software product including:
message generation instructions for generating modified ICMP messages, said messages including a constant time-to-live (TTL) value and the IP address of a remote computational device;
message transmission instructions for transmitting said modified ICMP messages to said IP address;
message reading instructions for reading response messages received in response to said modified ICMP messages;
address determination instructions for determining the address of a network support device in most direct communication with the remote computational device on the basis of data provided by the message reading instructions.

13. A software product according to claim 12, wherein the message reading instructions including response type instructions for determining the type of a response message, the embedded TTL value and the address of a network support device originating said response message.

14. A software product according to claim 13, wherein the address determination instructions determine if a response message contains the IP address of the network support device in most direct communication with the remote computational device on the basis of the type of the response message and the corresponding embedded TTL value.

15. A software product according to claim 14, wherein the address determination instructions include instructions for extracting from said messages the address of the network support device returning a message of the ICMP_TTL_exceeded type with the highest embedded TTL value of the response messages.

16. A software product according to claim 14, wherein the address determination instructions include instructions for determining said address by recording the lowest TTL value embedded as a constant amongst ICMP_Echo_Reply type messages of the response messages and then retrieving an address of a response message having an embedded TTL value of one less than said lowest TTL value.

17. A software product according to claim 14, wherein the address determination instructions include instructions for determining said address by recording the originating address of an ICMP_machine_unreachable type response message.
